(19) United States
(12) Patent Application Publication
(10) Pub. No.: US 2009/0198398 A1
(43) Pub. Date: Aug. 6, 2009

(54) Drive-and-control system for hybrid vehicles

(75) Inventor: Kazunao Yamada, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/322,009

(22) Filed: Jan. 28, 2009

(30) Foreign Application Priority Data
Jan. 31, 2008 (JP) 2008-21113

(51) Int. Cl. B60W 20/00; G06F 17/00; B60W 10/04

(52) U.S. Cl. 701/22; 903/930

(57) ABSTRACT

A schedule of control indexes can be planned for a route providing high accuracy control of an engine, a motor and a battery in a hybrid vehicle. Running information used to determine control indexes is collected while a vehicle is run from a point of departure to a destination and stored in a storage medium. When the vehicle has reached a destination, a schedule of control indexes is planned on the basis of the stored running information. Control of the hybrid vehicle using the plan reduces fuel consumption of an engine from the point of departure to the destination.

### CROSS REFERENCE TO RELATED APPLICATIONS

The present application is based on Japanese Application No. 2008-021113, filed on Jan. 31, 2008 and incorporated herein by reference.

### BACKGROUND OF THE INVENTION

1. Field of the Invention

The present invention relates to a drive-and-control system in a hybrid vehicle controlling an engine and a motor so that an amount of charge in a battery will approach predetermined control indexes.

2. Description of the Related Art

A drive-and-control system for hybrid vehicles is known that collects a running history of vehicle velocities and other metrics in association with a predetermined zone, learns the running history, determines a schedule of control indexes in association with the predetermined zone on the basis of the learned running history and the road situations of a route to a destination so that a fuel consumption to be required until a vehicle reaches the destination will be minimal, and controls an engine and a motor according to the schedules of control indexes. Reference can be made, for example, to JP-A-2000-333305 and JP-A-2001-183150.

Even if a precise point of departure and a destination change, the systems described in JP-A-2000-333305 and JP-A-2001-183150 collect a running history of vehicle velocities, gradients, and other metrics, average the vehicle velocities, gradients, and others in association with the predetermined zone, and learn the mean vehicle velocity, gradient, and the like. Disadvantages arise in that, since the vehicle velocities and other values collected in, for example, a zone in which the running frequency is high are averaged with values for a zone in which running frequency is low, the accuracy of the schedule of control indexes is disadvantageously degraded for the zone representing the highest frequency of travel. In particular, when an acceleration is calculated based on a change in the vehicle velocity, if a schedule of control indexes is planned using the averaged vehicle velocities, gradients, and accelerations, the accuracy of the schedule of control indexes for a zone in which the running frequency is higher gets lower.

### SUMMARY OF THE INVENTION

The present invention addresses the foregoing and other disadvantages, and is drawn to determining a schedule of control indexes resulting in a high accuracy.

To accomplish the above objective, a drive-and-control system can be mounted in a hybrid vehicle run using an engine and a motor as running power sources, and can implement drive and control using at least one of the engine and motor as the power source so that an amount of charge in a battery will approach predetermined determined control indexes. The drive-and-control system for hybrid vehicles includes a running information storage means that collects running information used to determine control indexes, at predetermined intervals while the vehicle is run, and stores the running information in a memory means. A control index storage control means that, when deciding that the vehicle has reached a target point, plans a schedule of control indexes in association with a predetermined zone on the basis of the running information stored in the memory means while the vehicle is run from a point of departure to the target point, so that a fuel consumption of an engine required for a route leading from the point of departure to the target point will be reduced, and stores the schedule of control indexes in the memory means.

In accordance with the above constitution, when a decision is made that the vehicle has reached the target point, a schedule of control indexes is planned in association with the predetermined zone on the basis of running information stored in the memory means while the vehicle is run from a point of departure to the target point, so that a fuel consumption of an engine required for a route leading from the point of departure to the target point will be reduced, and stored in the memory means. Therefore, the running information will not be averaged, and the schedule of control indexes can be planned with high accuracy.

The control index may be an amount of charge stored in a battery from which electrical power is fed to the motor.

The running information storage means collects running information needed to determine control indexes in association with a predetermined zone, and stores the running information in the memory means.

A decision means decides whether a schedule of control indexes for a route from the current position of the vehicle to the target point of the vehicle is stored in the memory means. An assisted control processing means implements drive and control according to the schedule of control indexes stored in the memory means when the decision means decides that the schedule of control indexes is stored in the memory means.

When a decision is made that the schedule of control indexes for the route from the current position of the vehicle to the target point thereof is stored in the memory means, drive and control can be implemented according to the schedule of control indexes stored in the memory means.

The control index storage means determines a control index at intervals of a certain running distance.

When a control index is determined in association with each road identifier, if the vehicle is run even slightly off a route from a point of departure to a target point in the middle of the route during a subsequent trip, the road identifier of a road on which the vehicle is run and the road identifier associated with the control index do not equal each other. Eventually, drive and control may presumably not be able to be implemented according to the schedule of control indexes. However, since the control index is determined at intervals of a certain running distance, even when the vehicle is run slightly off of the previous route along which the vehicle was run, when the vehicle is returned to the previous route, implementation of the drive and control of the engine and motor can be restored.

The control index storage control means further determines a control index in association with each road identifier.

Since the control index is determined in association with each road identifier, as long as the vehicle is not run off the route along which the vehicle was previously run, drive and control can be implemented with high accuracy according to the schedule of control indexes.

The control index storage control means determines a control index at intervals of a certain running distance for a zone extending from a point of departure to the first point, determines the control index in association with each road identifier for a zone extending from the first point to the second point preceding a target point, and determines the control index at intervals of the certain running distance for a zone extending from the second point to the target point.

In the vicinity of a point of departure or in the vicinity of a target point, the precision in calculation of a vehicle position may be so low that a road identifier of a road on which the vehicle is located may not be able to be identified. Therefore, in such a situation, if a control index is determined in association with each road identifier, and the road identifier cannot be identified, there is a possibility that drive and control may not be able to be implemented with high accuracy according to the schedule of control indexes. Accordingly, for the zone from the point of departure to a first point, the control index is determined at intervals of a certain running distance. For the zone from the first point to a second point that precedes the target point, the control index is determined in association with each road identifier. For the zone from the second point to the target point, the control index is determined at intervals of the certain running distance. Therefore, drive and control can be implemented with high accuracy according to the schedule of control indexes.

The control index storage control means determines a control index in association with each road identifier only for a zone in which the road identifier can be discriminated.

The assisted control processing means includes a route decision means that decides whether the vehicle is run off of a route from a point of departure to a target point of the vehicle. If the route decision means decides that the vehicle is run off of the route, control indexes determined for a place immediately preceding a place in which the vehicle is run off the route are used to implement drive and control.

If a decision is made that the vehicle is run off of a route, control indexes determined for a place immediately preceding the place where the vehicle is run off of the route are used to implement drive and control. Therefore, even when the vehicle is run slightly off the route, the drive and control can be implemented according to the schedule of control indexes.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a diagram illustrating an exemplary configuration of a drive-and-control system for hybrid vehicles in accordance with a first embodiment;

FIG. 2 is a diagram illustrating an exemplary configuration of a navigation ECU;

FIG. 3 is a flowchart illustrating exemplary control target value storage processing;

FIG. 4 is a flowchart illustrating exemplary data collection processing;

FIG. 5 is a diagram illustrating an example storing running information in a durable storage medium;

FIG. 6 is a flowchart illustrating exemplary charging plan forming processing;

FIG. 7A is a diagram illustrating an example of acquiring velocities and road gradients within a planning zone;

FIG. 7B is a diagram illustrating an example of determining a running method in association with each road identifier for a planning zone;

FIG. 8 is a diagram illustrating an example of a prospective transition in a target SOC;

FIG. 9 is a flowchart illustrating exemplary control target value learning processing;

FIG. 10 is a flowchart illustrating run-time processing;

FIG. 11 is a flowchart illustrating assisted control processing;

FIG. 12 is a diagram illustrating exemplary processing to be performed by a control unit where the current position of a vehicle departs from a route;

FIG. 13 is a flowchart illustrating exemplary charging plan forming processing in accordance with a second embodiment;

FIG. 14 is a flowchart illustrating exemplary charging plan forming processing in accordance with a third embodiment; and

FIG. 15 is a flowchart illustrating exemplary charging plan forming processing in accordance with a fourth embodiment.

### DETAILED DESCRIPTION OF EXEMPLARY EMBODIMENTS

### First Embodiment

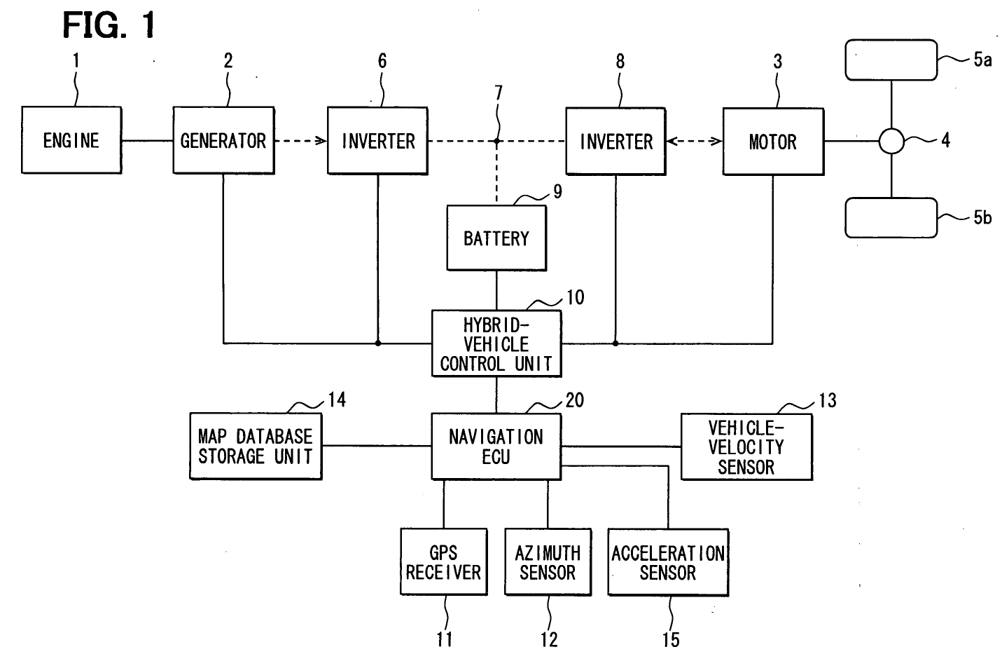

FIG. 1 schematically shows the outline configuration of a hybrid vehicle in which a drive-and-control system for hybrid vehicles in accordance with a first embodiment is mounted. In the hybrid vehicle, an engine 1 such as an internal combustion engine, a generator 2, a motor 3 such as an electric motor, differential gears 4, a tire 5a, a tire 5b, an inverter 6, a direct-current (DC) link 7, an inverter 8, a battery 9, a hybrid-vehicle control unit 10, a global positioning system (GPS) receiver 11, an azimuth sensor 12, a vehicle-velocity sensor 13, a map database storage unit 14, an acceleration sensor 15, and a navigation electronic control unit (ECU) 20 are mounted.

The hybrid vehicle is run using the engine 1 and motor 3 as power sources. When the engine 1 is used as the power source, the torque of the engine 1 is conveyed to the tires 5a and 5b via a clutch mechanism (not shown) and the differential gears 4. When the motor 3 is used as the power source, electrical DC power fed from the battery 9 is converted into electrical alternating-current (AC) power via the DC link 7 and inverter 8. The motor 3 is started with the electrical AC power, and the torque of the motor 3 is conveyed to the tires 5a and 5b via the differential gears 4. Hereinafter, a running mode in which the engine 1 alone is used as the power source shall be called an engine-run mode. A running mode in which at least the motor 3 out of the engine 1 and motor 3 is used as the power source shall be called an assisted run mode.

The torque of the engine 1 is also conveyed to the generator 2, and the generator 2 generates electrical AC power with the torque. The generated electrical AC power is converted into electrical DC power via the inverter 6 and DC link 7. The electrical DC power is stored in the battery 9. Charging the battery 9 by fuel based operation of the engine 1, which can be referred to as internal-combustion charging, is initiated by the start of the engine 1.

When the hybrid vehicle is decelerated by a braking mechanism (not shown), resistance derived from the deceleration is applied as torque to the motor 3. In accordance with an effect referred to as regenerative charging, the torque produces electrical AC power in the motor 3, which is converted into electrical DC power via the inverter 8 and DC link 7. The electrical DC power is stored in the battery 9.

In response to a command, message, or other indication sent from or provided by the navigation ECU 20, the hybrid-vehicle control unit 10 controls execution or non-execution of the above described start of the generator 2, motor 3, inverter 6, inverter 8, and battery 9. The hybrid-vehicle control unit 10 may be realized with, for example, a microcomputer or hardware including dedicated circuitry for realizing facilities described below. It will be appreciated that processing can be performed below according to the various steps described below in great detail and based on the structure described herein.

To be more specific, the hybrid-vehicle control unit 10 can perform processing (A) and (B) described below based on stored values including a current state-of-charge (SOC) value and a reference SOC value.

(A) The reference SOC value can be varied depending on a control target value that is a target SOC value serving as a control index to be inputted from the navigation ECU 20. The actuators for the generator 2, motor 3, inverter 6, inverter 8, and battery 9 are controlled so that the amount of charge stored in the battery 9 of the hybrid vehicle will approach the target SOC value.

(B) A current SOC value is regularly posted to the navigation ECU 20.

The SOC value is an index indicating the amount of charge remaining in the battery. The larger the SOC value, the larger the amount of remaining charge. A current SOC value is the current state of charge in the battery 9. The hybrid-vehicle control unit 10 sequentially detects the state of the battery 9 so as to repeatedly update the current SOC value. The reference SOC value is a control target value, for example, 60 % based on whether the hybrid-vehicle control unit 10 decides to adopt a generation mode or an assisted run mode. The reference SOC value can be varied under the control of the navigation ECU 20.

Based on the control target value inputted from the navigation ECU 20, the hybrid-vehicle control unit 10 implements control to change the running mode of the hybrid vehicle from the engine-run mode to the assisted run mode or vice versa, and to switch execution and non-execution of internal-combustion charging or regenerative charging. The control target value in the present embodiment is the reference or target SOC value. The hybrid-vehicle control unit 10 determines a running method and controls the actuators according to the determined running method so that the current SOC value will be retained at the target SOC value or a neighboring value.

The GPS receiver 11, azimuth sensor 12, and vehicle-velocity sensor 13 are known sensors that identify the position of the hybrid vehicle, the advancing direction thereof, and the running velocity thereof respectively. The map database storage unit 14 can be a storage medium in which map data is stored. The acceleration sensor 15 is a known sensor that identifies the acceleration of the vehicle. The road gradient or inclination is calculated using the vehicle-velocity sensor and acceleration sensor.

The map data includes node data items representing intersections, and link data items representing road zones as links, each road zone linking adjacent intersections. A node data item can contain an identification number of the node, location information associated with the node, and a type associated with the node. A link data item contains an identification number of the link referred to hereinafter as a link ID, position information associated with the link, and a type associated with the link.

The positional information on a link contains locational data items of shape-complementing points on the link, and data of a segment linking two adjoining ones out of the nodes at both ends of the link and the shape-complementing points. The data of each segment contains the ID of the segment, the gradient thereof, the orientation thereof, the length thereof, and other information.

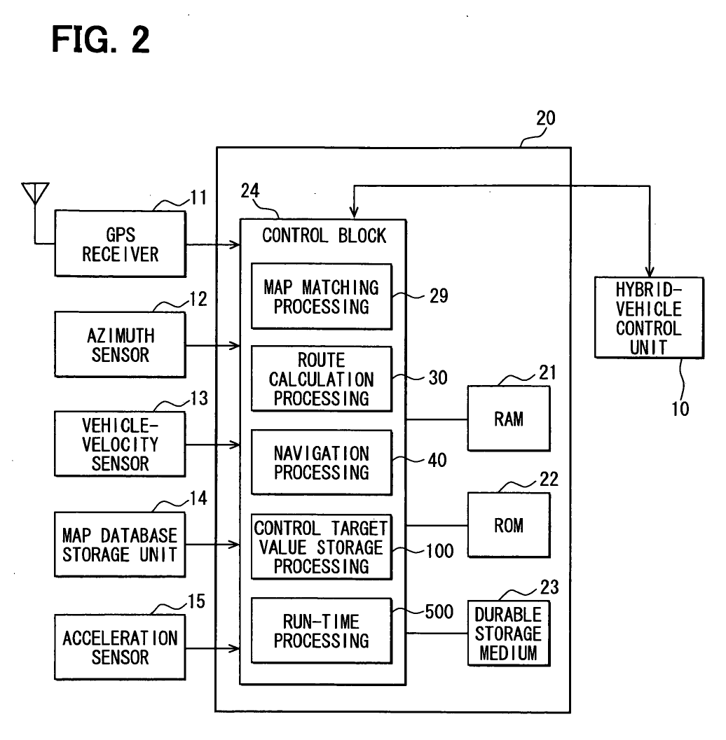

As shown in FIG. 2, the navigation ECU 20 includes a RAM 21, a ROM 22, a durable storage medium 23 in which data can be written, and a control block 24. The durable storage medium can refer to a storage medium that can hold data even when a main power supply voltage to the navigation ECU 20 is removed. The durable storage medium 23, for example, a nonvolatile storage medium can include a hard disk, a flash memory, an EEPROM, a backup RAM, or the like.

The control block 24 runs a program read from the ROM 22 or durable storage medium 23. The control block 24 reads information from the RAM 21, ROM 22, and durable storage medium 23, writes information in the RAM 21 and durable storage medium 23, and transfers signals to or from the hybrid-vehicle control unit 10, GPS receiver 11, azimuth sensor 12, vehicle-velocity sensor 13, map database storage unit 14, and acceleration sensor 15.

Specifically, the control block 24 implements map matching processing 29, route calculation processing 30, navigation processing 40, control target value storage processing 100, and run-time processing 500 by running predetermined programs.

In the map matching processing 29, the control block 24 decides based on positional information and other information acquired from the GPS receiver 11, azimuth sensor 12, vehicle-velocity sensor 13, and acceleration sensor 15, regarding on which roads on a map in the map database storage unit 13 the current position lies. When the vehicle has just begun movement, the decision in the map matching processing 29 is often made inaccurately. The decision is often made accurately at the timing at which the vehicle enters a new segment after being run for some time.

In the route calculation processing 30, when a user uses an operating unit (not shown) to designate a destination, the control block 24 determines an optimal route to the designated destination on the basis of map data.

In the navigation processing 40, the control block 24 uses an image display device and a loudspeaker, which are not shown, to give guide indication, which helps a driver run the hybrid vehicle along a running route to a destination, to the driver.

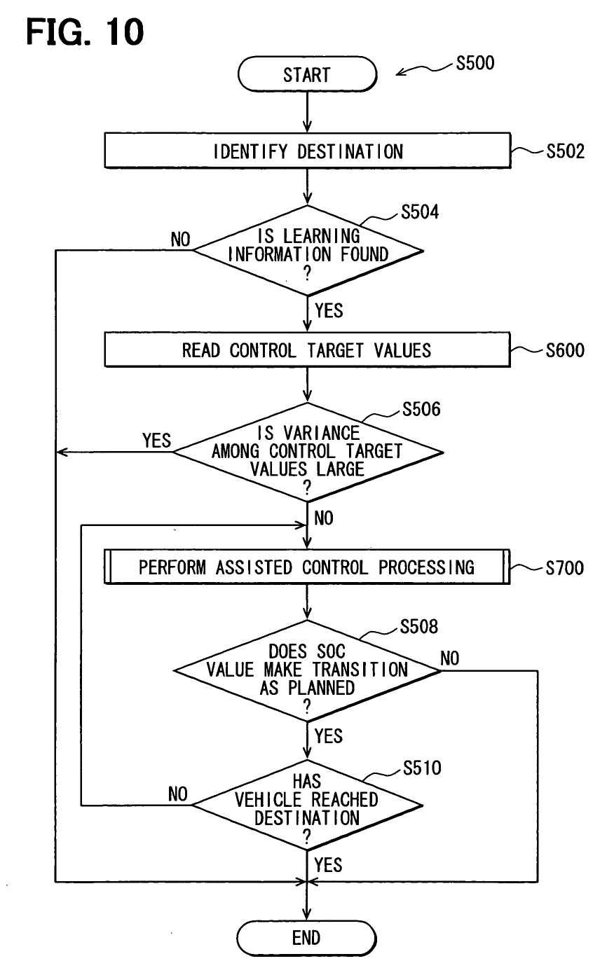

In the control target value storage processing 100, the control block 24 collects running information at intervals of a certain running distance while the vehicle is run from a point of departure to the destination, stores the running information in the durable storage medium 23, plans a schedule of control indexes in association with a predetermined zone along the route from the point of departure to the destination on the basis of the running information stored in the durable storage medium 23, and stores the schedule of control indexes in the durable storage medium 23. During run-time processing of S500 mentioned in FIG. 10, if a decision is made at the next time of departure that a schedule of control indexes relevant to the same point of departure or the same destination is stored in the durable storage medium 23, the engine and motor are driven and controlled according to the schedule of control indexes stored in the durable storage medium 23. Thus, the vehicle can be run based on the planned schedule of control indexes with high accuracy.

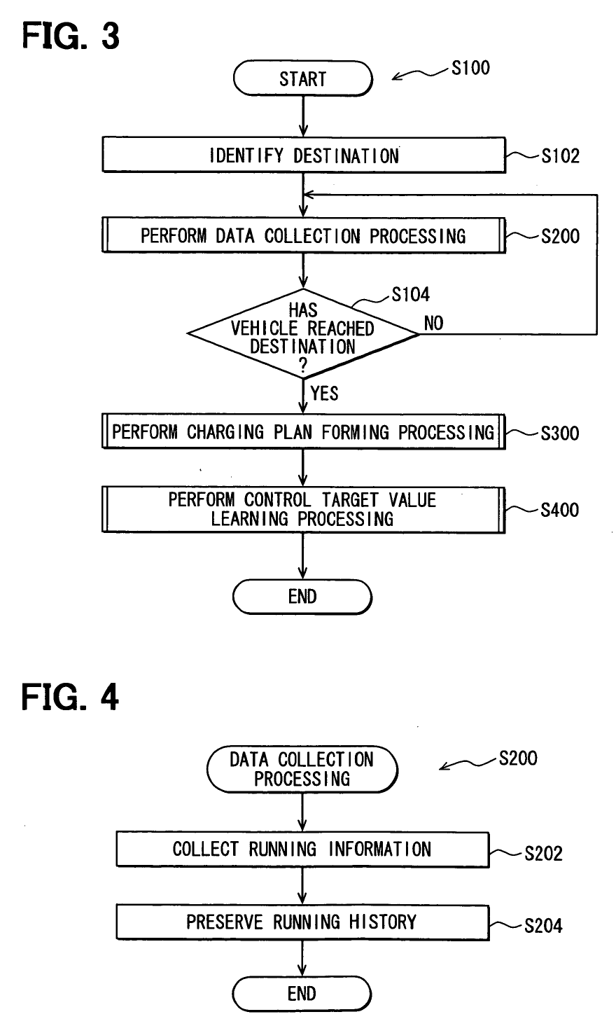

FIG. 3 is a flowchart of the control target value storage processing 100. When the ignition switch of the vehicle is turned on, the drive-and-control system is brought to an operating state. The control block 24 implements the various processing. The control block 24 implements the processing mentioned in FIG. 3 responsive to manipulations performed by an occupant.

A destination can first be identified at S102. Specifically, a screen image prompting a user to enter a destination is displayed. A point or a facility designated with the manipulations performed through the screen image by the occupant is recognized as a destination.

Thereafter, data collection processing of acquiring running information is implemented at S200. FIG. 4 is a flowchart of the data collection processing of S200.

The control block 24 can first acquire running information at S202. In the present embodiment, a vehicle velocity and a road gradient are collected as the running information at intervals of a certain running distance such as, for example, 5 m. The road identifier of a road on which the vehicle is located can also be identified.

A running history can then be preserved at S204. Specifically, the vehicle velocity and road gradient collected at S202 are stored in the durable storage medium 23 in association with the road identifier of the road on which the vehicle is located.

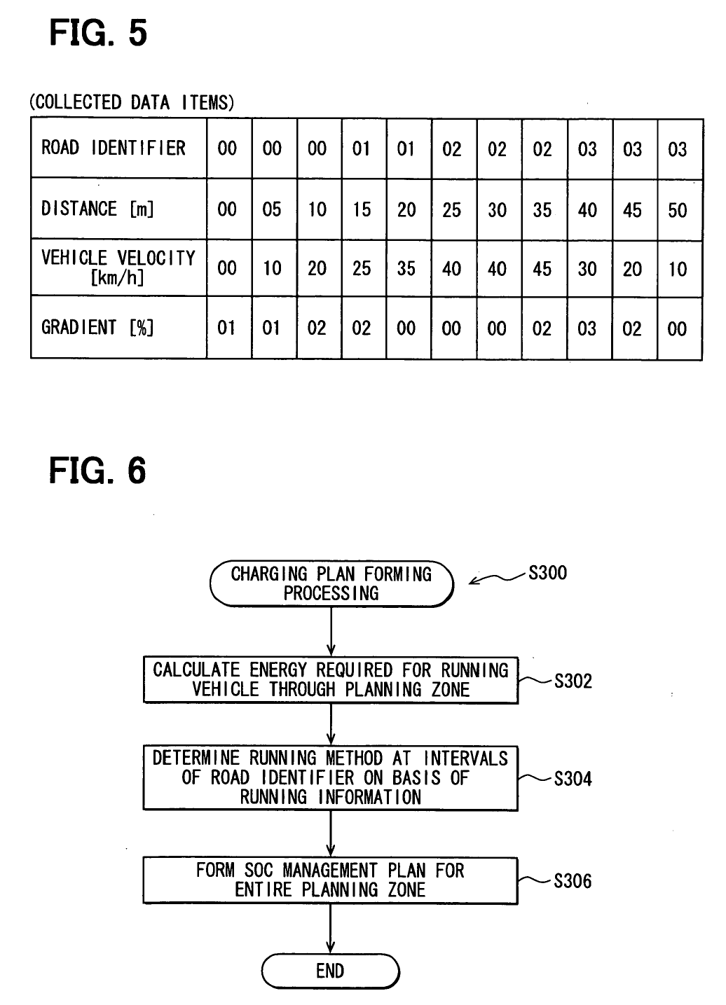

FIG. 5 shows an example of the running information stored in the durable storage medium 23. As shown in the drawing, in the durable storage medium 23, the vehicle velocities and road gradients collected at intervals of a certain running distance are stored in association with the road identifiers. The road identifier is a link ID or a segment ID which can be used to discriminate or distinguish one road zone from another.

Referring back to the flowchart of FIG. 3, it can be decided whether the vehicle has reached the destination at S104. Specifically, it is decided whether the vehicle has reached the destination based on whether the current position of the vehicle falls within a certain range of the destination using the destination as a reference.

If the current position of the vehicle does not fall within the certain range of the destination, corresponding to NO at S102, the data collection processing of S200 is repeated. Namely, the processing associated with collecting the vehicle velocity and road gradient at intervals of the certain distance, and storing the vehicle velocity and road gradient in association with the road identifier in the durable storage medium 23 is repeated.

If the current position of the vehicle falls within the certain range of the destination, corresponding to YES at S102, the charging plan forming processing of S300 is then implemented. FIG. 6 is a flowchart of the charging plan forming processing of S300. During the charging plan forming processing of S300, a scheduled running method for the vehicle within a planning zone is formed as a charging plan for the planning zone.

Specifically, first, a running route from a point of departure to a destination is regarded as a planning zone, and energy required for running the vehicle through the planning zone is calculated at S302 based on the running information stored in the durable storage medium 23 while the vehicle is run from the point of departure to the destination. One suitable method for calculating the required energy is described in JP-A-2001-183150 and “Development of a New-energy Automobile” (p. 123-124, CMC Publishing) the contents of which are incorporated herein by reference.

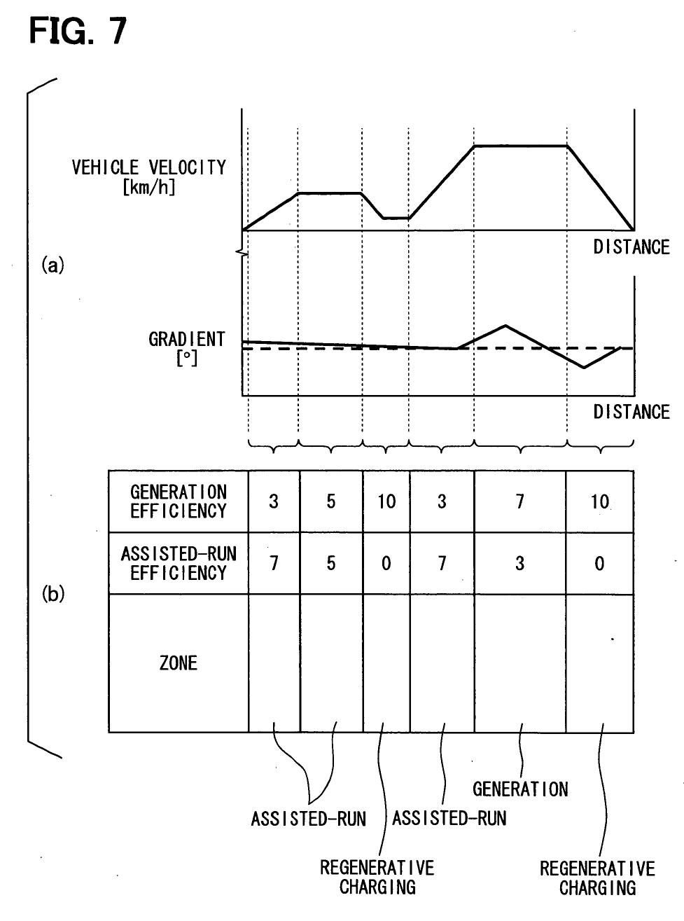

Thereafter, the running method is determined at S304 in association with each road identifier on the basis of the running information stored in the durable storage medium 23. Specifically, a reference SOC value is acquired from the. hybrid-vehicle control unit 10. Based on the reference SOC value and the running information stored in the durable storage medium 23, a generation efficiency value and an assisted run efficiency value are calculated for the planning zone while the vehicle is run from the point of departure to the destination. A control method including a regenerative charging method, a generation method, or an assisted run method is determined in association with each road identifier. FIG. 7A shows an example of vehicle velocities and road gradients collected over the planning zone. FIG. 7B shows an example of running methods determined for the planning zone in association with respective road identifiers.

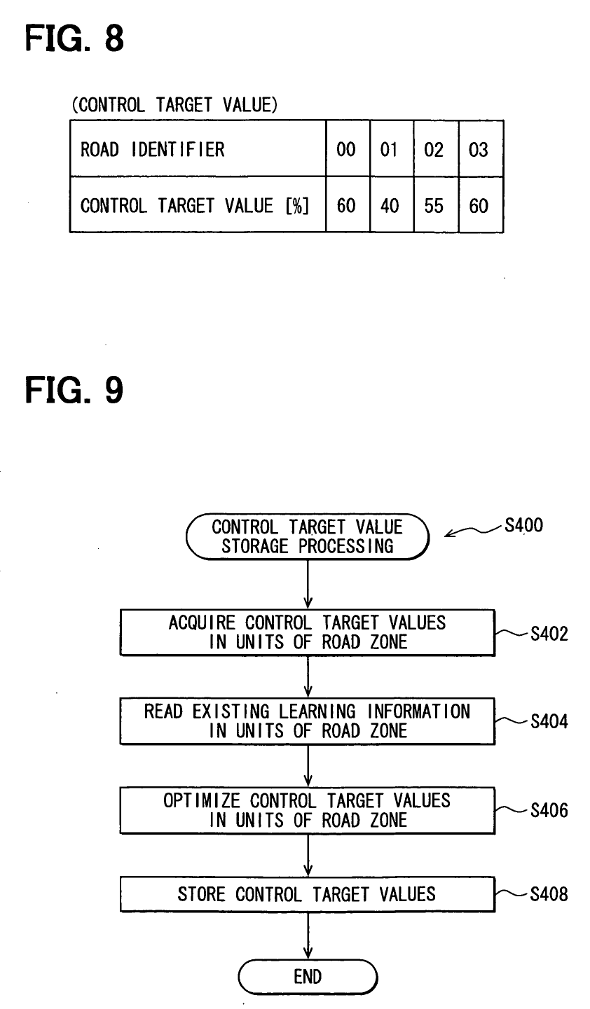

Thereafter, an SOC management plan equivalent to a schedule of control indexes for the entire planning zone is formed at S306 based on the running information stored in the durable storage medium 23 while the vehicle is run from the point of departure to the destination. The SOC management plan includes prospective transitions in a target SOC value or a control target value until the vehicle reaches the destination. Use of a prospective transition in the target SOC value is described in JP-A-2001-183150 or “Development of a New-energy Automobile” (p. 123-124, CMC Publishing). The details of the prospective transition in the target SOC value will be omitted. FIG. 8 shows an example of the prospective transition in the target SOC value. As shown in the drawing, in the present embodiment, the SOC management plan in which target SOC values are specified in association with road identifiers within the planning zone is formed.

Referring back to FIG. 3, the control target value learning processing of S400 in which control target values are learned and stored in the durable storage medium 23 is implemented. FIG. 9 is a flowchart of the control target value learning processing of S400.

In the control target value learning processing, control target values are first acquired in units of a road zone at S402. Specifically, the control target values that are the target SOC values and are specified in association with the road identifiers in the SOC management plan are acquired from the durable storage medium 23.

Thereafter, existing learning information is read in units of a road zone at S404. Specifically, if the control target values for the same planning zone are already stored in the durable storage medium 23, the control target values for the same planning zone are read from the durable storage medium 23. If the control target values for the same planning zone are not stored in the durable storage medium 23, reading the control target values is not carried out, but the processing proceeds to the next S406.

At S406, the control target values are optimized in units of a road zone. If the control target values for the same planning zone are already stored in the durable storage medium 23, the simple mean values between the control target values for the same planning zone stored in the durable storage medium 23 and the control target values acquired at S402 are adopted as new control target values. If the control target values for the same planning zone are not stored in the durable storage medium 23, the control target values acquired at S402 are regarded as new control target values.

Thereafter, the new control target values are stored in the durable storage medium 23 at S408. Specifically, the control target values that are target SOC values and specified in relation to the point of departure and destination in association with road identifiers are stored in the durable storage medium 23.

FIG. 10 is a flowchart of the run-time processing 500. After the ignition switch of the vehicle is turned on, the processing mentioned in FIG. 10 is implemented responsive to the manipulations associated with designating a destination by an occupant.

To begin with, a destination is identified at S502. Thereafter, it is decided whether learning information is found at S504. Specifically the current position of the vehicle is regarded as a point of departure and the destination identified at S502 is used. It is decided whether an SOC management plan or a schedule of control indexes relating to the same point of departure and same destination is stored in the durable storage medium 23.

If the SOC management plan relating to the same point of departure and same destination is stored in the durable storage medium 23, corresponding to YES at S504, the control target values are then read at S600. Specifically, the control target values for each of the zones along the route from the current position of the vehicle to the destination specified in the SOC management plan are read from the durable storage medium 23.

Thereafter, it is decided whether a variance among the control target values for each zone specified in the SOC management plan is large at S506. Specifically, a mean value among the control target values for each zone is calculated. It is decided whether the variance among the control target values for each zone is large based on whether the difference between the maximum value and mean value of the control target values for each zone or the difference between the minimum value and mean value of the control target values for each zone is equal to or larger than a predetermined threshold.

If the difference is equal to or larger than the threshold, corresponding to YES at S506, the processing is terminated. The hybrid-vehicle control unit 10 implements drive and control so that the amount of charge in the battery 9 will approach the reference SOC value.

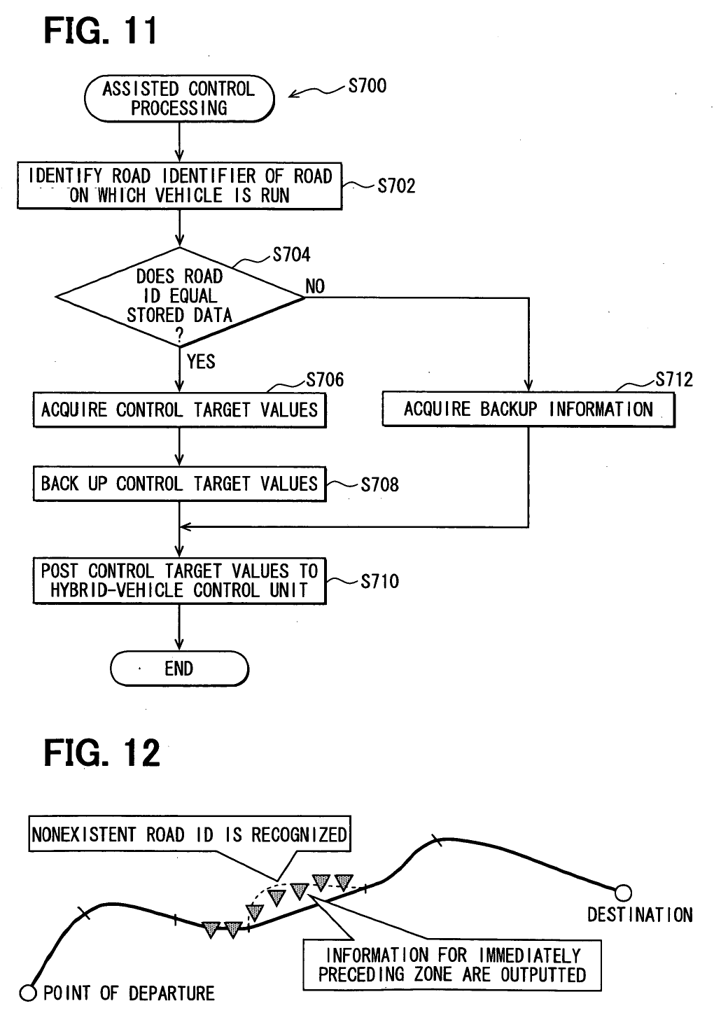

If the difference falls below the threshold, corresponding to NO at S506, the assisted control processing of S700 is implemented in accordance with, for example, the flowchart shown in FIG. 11.

The control block 24 first identifies at S702 a road identifier of a road on which the vehicle is run based on, for example, the result of the map matching processing 29.

Thereafter, it is decided whether the road identifier, which can be a road ID, is equal to the stored data at S704. Specifically, it is decided whether the road identifier identified at S702 is equal to the road identifier assigned to the road and specified in the SOC management plan.

If the vehicle is run along the route from the point of departure to the destination, corresponding to YES at S704, control target values for the road on which the vehicle is run are acquired at S706, and the acquired control target values are backed up at S708. Specifically, the acquired control target values are stored in the RAM 21. If the control target values are already stored in the RAM 21, the latest control target values are stored in the RAM 21 by overwriting the RAM 21.

Thereafter, the control target values are posted to the hybrid-vehicle control unit 10 at S710. The hybrid-vehicle control unit 10 implements drive and control so that the amount of charge in the battery 9 will approach each of the control target values.

If the vehicle is run off of the route from the point of departure to the destination, corresponding to NO at S704, backup information is then acquired at S712. Namely, the latest control target values stored in the RAM 21 at S708 are read.

In such a case, at S710, the latest control target values read from the RAM 21 are posted to the hybrid-vehicle control unit 10.

Referring back to FIG. 10, it is decided at S508 whether the SOC value makes a transition as planned based on whether the current SOC value makes a transition so as to approach each of the control target values.

It is decided at S510 whether the vehicle has reached the destination based on whether the vehicle position falls within the predetermined range of the destination, with the destination as a reference.

When the current SOC value makes a transition so as to approach each of the control target values, if the vehicle has not reached the destination, corresponding to YES at S508 and NO at S510, the assisted control processing of S700 is repeatedly implemented until the vehicle reaches the destination.

If the current SOC value does not make a transition so as to approach each of the control target values, corresponding to NO at S508, the processing is terminated. In such a case, the hybrid-vehicle control unit 10 implements drive and control so that the amount of charge in the battery 9 will approach the reference SOC value.

As shown in FIG. 12, if the current position of the vehicle is separated from the route that leads from the point of departure to the destination, as indicated with a solid line in the drawing, the control block 24 posts information to the hybrid-vehicle control unit 10. The information can include control target values for a zone immediately preceding the zone within which the vehicle position separates from the route. Therefore, even when the current position of the vehicle separates from the route leading from the point of departure to the destination and being indicated with the solid line, if the current position immediately returns to the route, the SOC value will make a transition to a value that is close to the planned value.

According to the foregoing constitution, when a decision is made that the vehicle has reached the destination, a schedule of control indexes is planned in association with a predetermined zone on the basis of running information, which are stored in the durable storage medium 23 while the vehicle is run from the point of departure to the destination, so that the fuel consumption of the engine required for the route from the point of departure to the target point will be reduced, and then stored in the durable storage medium 23. Therefore, the running information will not be averaged, but the schedule of control indexes can be planned with high accuracy.

The merit derived from storage in the form of control indexes is that the control indexes can be uniquely determined as information for a zone and are superior to vehicle velocities in terms of consistency. For example, assuming that a certain zone is defined with a control index of A, as long as the energy use tendency remains unchanged within the zone, the value of A will not vary by a large amount from one run to another. In contrast, assuming that a vehicle velocity is adopted as information for a certain zone, if the vehicle is decelerated in the middle of the zone in line with traffic flow, a degree of variance associated with the vehicle velocity values expands. The defining feature of the zone is lost by a degree proportional to the running frequency in the zone and the degree of variation between velocity values from one run to the next. According to the above described constitution, since a schedule of control indexes is stored in association with a predetermined zone, even when control indexes are simply averaged, the feature of the zone will not be greatly lost.

If a decision is made that a schedule of control indexes for a route from the current position of the vehicle to a target point of the vehicle is stored in the durable storage medium 23, drive and control can be implemented according to the schedule of control indexes stored in the durable storage medium 23.

Since a control index is determined in association with each road identifier, unless the vehicle is run off of a route along which the vehicle was previously run, drive and control can be implemented with high accuracy according to the schedule of control indexes.

### Second Embodiment

In a first embodiment, in the charging plan forming processing of S300 mentioned in FIG. 6, the control block 24 determines a control method, which can include: a regenerative charging method, a generation method, or assisted-run method; and a control target value such as, for example, a target SOC value, in association with each road identifier for establishing the planning zone from a point of departure to a destination, and forms an SOC management plan equivalent to a schedule of control indexes for the entire planning zone. In the present embodiment, the control method and control target value that is the target SOC value are determined at intervals of a certain running distance in order to form the SOC management plan for the entire planning zone.

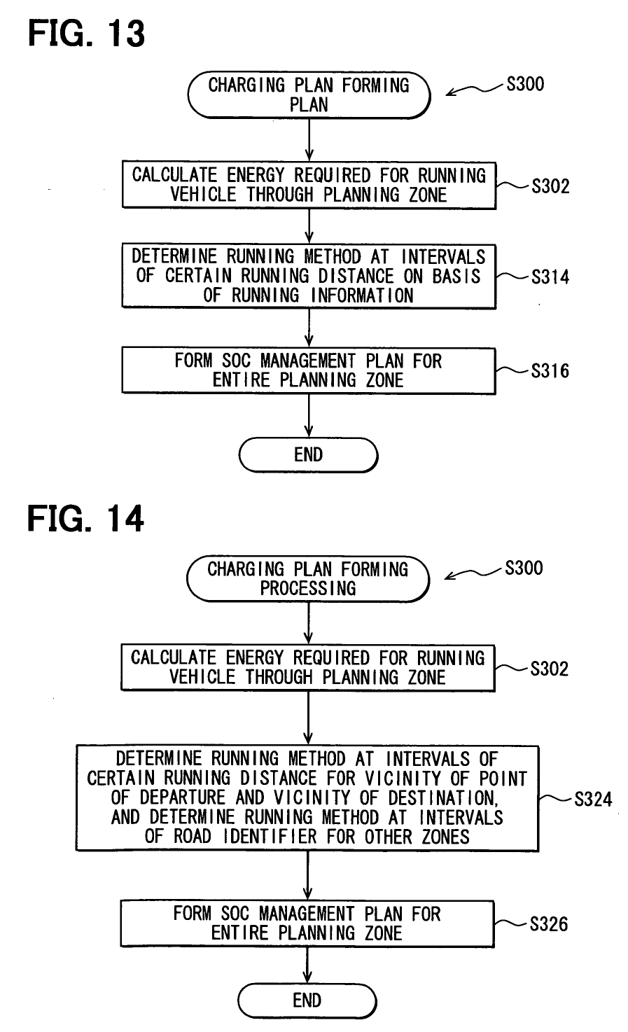

FIG. 13 is a flowchart of charging plan forming processing of S300 in accordance with the present embodiment. The same reference numerals will be assigned to the components identical to those of the above described embodiment, and an iterative description will be omitted. Different components will mainly be described below.

At S302, energy required for running the vehicle through a planning zone is calculated based on running information stored in the durable storage medium 23. At S314, a running method is determined at intervals of a certain running distance on the basis of the running information stored in the durable storage medium 23. Specifically, a reference SOC value is acquired from the hybrid-vehicle control unit 10. Based on the reference SOC value and the running information stored in the durable storage medium 23 while the vehicle is run from a point of departure to a destination, a control method that is any of a regenerative charging method, a generation method, and an assisted-run method and a control target value that is a target SOC value are determined at intervals of the certain running distance.

At S306, an SOC management plan for the entire planning zone will be formed based on the control methods and control target values determined at S304.

In the present embodiment, the SOC management plan having the control method and control target value determined at intervals of the certain running distance is formed as mentioned above. Assuming that the SOC management plan having the control method and control target value determined in association with each road identifier is formed as it is in a first embodiment, if the vehicle is run slightly off a scheduled route or if the precision in calculation of the current position of the vehicle is poor, drive and control may not be able to be implemented according to the SOC management plan. In the present embodiment, since the SOC management plan having the control method and control target value determined at intervals of the certain running distance is formed, even if the vehicle is run slightly off a scheduled route or if the precision in calculation of the current position of the vehicle is poor, drive and control can be implemented according to the SOC management plan.

### Third Embodiment

In the present embodiment, an SOC management plan is formed to have a control method and a control target value, which is a target SOC value, determined at intervals of a certain running distance for the vicinity of a point of departure and the vicinity of a destination, and to have the control method and control target value determined in association with each road identifier for the other zones. FIG. 14 is a flowchart of charging plan forming processing of S300 in accordance with the present embodiment.

The control block 24 calculates a value at S302 for the amount of energy required for running the vehicle through a planning zone, on the basis of running information stored in the durable storage medium 23. Thereafter, at S324, a running method and a control target value are determined at intervals of a certain running distance for a zone leading from a point of departure to the first point. The running method and control target value are determined in association with each road identifier for a zone leading from the first point to a second point preceding a destination. The running method and control target value are determined at intervals of the certain running distance for a zone leading from the second point to the destination. Thus, the control method and control target value are determined at intervals of the certain running distance for the vicinity of the point of departure and the vicinity of the destination, and are determined at intervals of the road identifier for the other zone.

At S306, an SOC management plan for the entire planning zone is formed based on the control methods and control target values determined at S324.

In the vicinity of a point of departure and the vicinity of a target point, the precision in calculation of a vehicle position is poor and a road identifier of a road on which the vehicle is located may not be identified. Therefore, if a control index is determined at intervals of the road identifier, there is a possibility that drive and control may not be able to be implemented according to the schedule of control indexes with high accuracy. However, according to the foregoing constitution, the control index is determined at intervals of a certain running distance for a zone leading from a point of departure to the first point, determined at intervals of the road identifier for a zone leading from the first point to the second point preceding a target point, and determined at intervals of the certain running distance for a zone leading from the second point to the target point. Therefore, drive and control can be implemented according to the schedule of control indexes with high accuracy.

### Fourth Embodiment

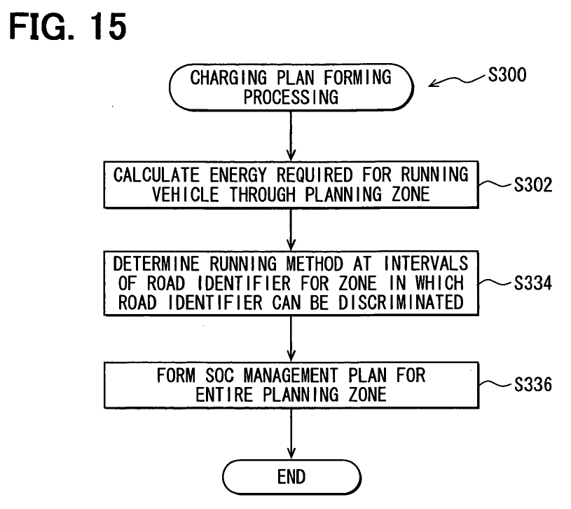

In a fourth embodiment, a control method and a control target value, which can include a target SOC value, are determined in association with each road identifier only in a zone in which the road identifier can be discriminated, and an SOC management plan is formed. FIG. 15 is a flowchart of charging plan forming processing of S300 in accordance with the present embodiment.

At S302, the control block 24 calculates energy required for running the vehicle through a planning zone on the basis of running information stored in the durable storage medium 23. Thereafter, at S334, the control block 24 determines a running method and a control target value in association with each road identifier only for a zone in which the road identifier can be discriminated.

At S336, an SOC management plan for the entire planning zone is formed based on the control methods and control target values determined at S334.

As mentioned above, a control index may be determined in association with each road identifier for a zone in which the road identifier can be discriminated.

### Other Embodiments

In the above described embodiments, a schedule of control indexes is planned in association with a predetermined zone on the basis of running information, which are stored in the durable storage medium 23 while the vehicle is run from a point of departure to a destination, so that the fuel consumption of the engine 1 for the route from the point of departure to the destination will be reduced, and stored in the durable storage medium 23. However, the inventive concept is not limited to embodiments involving only the route leading from the point of departure to the destination. Alternatively, any of various zones such as a route leading from the point of departure to a point of passage or a route having the point of passage designated as the point of departure and leading to the destination may be designated as the route, and a schedule of control indexes may be planned and stored in the durable storage medium 23.

In the above described embodiments, running information to be used to determine control indexes are acquired in association with a predetermined zone, and stored in the durable storage medium 23. Alternatively, the running information to be used to determine the control indexes may be acquired at intervals of a predetermined time, and stored in the durable storage medium 23.

In the above described embodiments, a control target value that is a target SOC value and indicates an amount of charge in the battery from which electrical power is fed to the motor is adopted as a control index, and a schedule of control indexes is planned. However, the present invention is not limited to the target SOC value. Data other than the target SOC value may be adopted as a control index, and a schedule of control indexes may be planned. Assuming that an SOC value required for advancing the vehicle into a certain zone is B and an SOC value required for withdrawing the vehicle from the zone is C, any control index may be adopted as long as a control can be implemented within the zone so that the SOC value will be changed from the value B to the value C.

At S406 in a first embodiment, the control target values acquired at S402 are stored in the durable storage medium 10 as they are. Alternatively, the simple means between the control target values for the same planning zone read from the durable storage medium 23 and the control target values acquired at S402 may be calculated and stored in the durable storage medium 10.

In the above described embodiments, a vehicle velocity and a road gradient are acquired as running information to be used to determine a control index, and the control index is determined based on the acquired running information. The present invention is not limited to the example. Alternatively, information other than the vehicle velocity and road gradient may be acquired in order to determine the control index.

As for the relationship of correspondence between the components of the above described embodiments and the components set forth in Claims, S200 corresponds to a running information storage means, S104, S300, or S400 corresponds to a control index storage control means, S504 corresponds to a decision means, S600 or S700 corresponds to an assisted control processing means, and S704 corresponds to a route decision means.

What is claimed is:

1. A drive-and-control system for mounting in a hybrid vehicle, the hybrid vehicle operated using an engine and a motor as power sources, the drive-and-control system driving and controlling the engine and the motor so that an amount of charge in a battery will approach a control index during a running from a point of departure to a target point, the drive-and-control system comprising:
a running information storage means for storing running information used to determine the control index in a memory while the vehicle is run; and
a control index storage control means for planning a schedule of control indexes in association with a predetermined zone, the schedule of the control indexes planned on the basis of the running information stored in the memory, when a decision was made that the vehicle had reached a target point, so that the fuel consumption of the engine for the route from the point of departure to the target point will be reduced, and stores the schedule of the control indexes in the memory.

2. The drive-and-control system for mounting in a hybrid vehicle according to claim 1, wherein the control index is a target amount for the charge in the battery from which electrical power is fed to the motor.

3. The drive-and-control system for mounting in a hybrid vehicle according to claim 1, wherein the running information storage means acquires running information used to determine the schedule of the control indexes for the predetermined zone, and stores the running information in the memory means.

4. The drive-and-control system for mounting in a hybrid vehicle according to claim 1, further comprising:
a decision means for deciding whether the schedule of the control indexes is stored in the memory; and
an assisted control processing means that implements drive and control according to the schedule of the control indexes if the decision means decides that the schedule of the control indexes is stored in the memory.

5. The drive-and-control system for mounting in a hybrid vehicle according to claim 1, wherein the control index storage control means determines the control index at intervals of a certain running distance.

6. The drive-and-control system for mounting in a hybrid vehicle according to claim 1, wherein the control index storage control means determines the control index in association with each road identifier.

7. The drive-and-control system for mounting in a hybrid vehicle according to claim 1, wherein the control index storage control means determines the control index at intervals of a certain running distance when near one or both of the point of departure and the destination, and in association with each road identifier at other points on the route.

8. The drive-and-control system for mounting in a hybrid vehicle according to claim 1, wherein the control index storage control means determines the control index at intervals of a certain running distance for a first portion of the predetermined zone from the point of departure to a first point, determines the control index in association with each road identifier for a second portion of the predetermined zone from the first point to a second point preceding the target point, and determines the control index at intervals of the certain running distance for a third portion of the predetermined zone from the second point to the target point.

9. The drive-and-control system for mounting in a hybrid vehicle according to claim 1, wherein the control index storage control means determines the control index at intervals of the road identifier only for a portion of the predetermined zone in which the road identifier can be discriminated.

10. The drive-and-control system for mounting in a hybrid vehicle according to claim 4, wherein:
the assisted control processing means includes a route decision means that decides if the vehicle is run off of the route leading from the point of departure to the target point of the vehicle; and
if the route decision means decides that the vehicle is run off the route, the control indexes that are determined for a portion of the predetermined zone immediately preceding a place in which the vehicle is run off of the route are used to implement drive and control.

11. A drive-and-control system for a hybrid vehicle capable of being operated using an engine and a motor as a motive power source, the drive-and-control system driving and controlling the engine and the motor so that an actual state of charge in a battery will approach a control index during a movement of the hybrid vehicle from a point of departure to a target point, a route from the point of departure to the target point divided into a plurality of predetermined zones, the control index representing a reference charge, the drive-and-control system comprising:
a memory;
a first control unit coupled to the memory, the first control unit configured to:
generate and store information in the memory, the information including running information associated with the movement from the point of departure to the target in each of the plurality of predetermined zones; and
establish control plan on the basis of the running information, the control plan established when the target point is reached, control plan for providing control of the engine and the motor so as to reduce a fuel consumption of the engine for the route, the control plan stored in the memory; and
a second control unit coupled to the memory and the first control unit, the second control unit configured to control the hybrid vehicle according to the control plan.

12. A drive-and-control system according to claim 11, wherein the control plan includes a control method and a schedule of values for the control index in each of the predetermined zones, the control method including one of a regenerative charging method, a generation method and an assisted-run method, the control index including a target level of charge of the battery, the second control unit controlling the hybrid vehicle according to the plan so as to maintain a level of charge on the battery at the target level of charge.

13. The drive-and-control system according to claim 11, wherein the second control unit controls the engine and the motor according to the plan when the hybrid vehicle is traveling on the route if the plan is determined to have been previously established and stored in the memory.

14. The drive-and-control system according to claim 11, wherein the first control unit generates and stores the running information in the each of the plurality of predetermined zones according to predetermined intervals.

15. The drive-and-control system according to claim 14, wherein the each of the predetermined zones is identified with a corresponding zone ID, and wherein the first control unit stores the running information for the predetermined intervals in the each of the plurality of predetermined zones in association with the corresponding zone ID.

16. The drive-and-control system according to claim 14, wherein the each of the predetermined zones is identified with a corresponding zone ID, and wherein the first control unit stores the schedule of values for the control index for the each of the plurality of predetermined zones in association with the corresponding zone ID.

17. The drive-and-control system according to claim 14, wherein the first control unit determines first values for the control index in each of the predetermined intervals of a certain running distance for a first one or more of the plurality of predetermined zones corresponding to a first portion of the route from the point of departure to a first point, determines second values for the control index in each of the predetermined intervals of the certain running distance for a second one or more of the plurality of predetermined zones corresponding to a second portion of the route from the first point to a second point preceding the target point, and determines third values for the control index in each of the predetermined intervals of the certain running distance for a third one or more of the plurality of predetermined zones corresponding to a third portion of the route from the second point to the target point.

18. The drive-and-control system according to claim 14, wherein:
the first control unit determines a position where the hybrid vehicle deviates from the route; and
the first control unit uses a control index associated with one of the predetermined intervals immediately preceding the position where the hybrid vehicle deviates from the route to control the engine and the motor.

19. The drive-and-control system according to claim 14, wherein a length of the predetermined intervals includes 5 meters.

20. The drive-and-control system according to claim 11, wherein the first control unit includes a navigation control unit and the second control unit includes a hybrid-vehicle control unit.
